(19) United States
(12) Patent Application Publication
(10) Pub. No.: US 2026/0139792 A1
(43) Pub. Date: May 21, 2026

(54) Retaining Clip

(71) Applicant: Illinois Tool Works Inc., Glenview, IL (US)

(72) Inventors: Chen Li, Shanghai (CN); Zhilin Li, Shanghai (CN)

(21) Appl. No.: 19/393,760

(22) Filed: Nov. 19, 2025

(30) Foreign Application Priority Data
Nov. 21, 2024 (CN) 202422854054.6

(51) Int. Cl. F16M 13/02; B60R 16/02; F16L 3/127; H02G 3/32

(52) U.S. Cl. CPC F16M 13/02; F16L 3/127; H02G 3/32; B60R 16/0215

(57) ABSTRACT

The present disclosure provides a retaining clip including a support, a first elastic arm and a second elastic arm. The support includes a base, a first supporting portion and a second supporting portion. The first supporting portion and the second supporting portion are respectively connected to two ends of the base and extend in a direction away from the base. The first elastic arm and a second elastic arm respectively extend from the first supporting portion and the second supporting portion toward the base. A distal end of the first elastic arm is closer to the base than the second elastic arm. The distal end of the first elastic arm and the base enclose a first space, and a distal end of the second elastic arm, a side of the first elastic arm facing the second supporting portion, and the base enclose a second space. The first elastic arm and the second elastic arm are configured to be elastic so as to clamp a first part in the first space or a second part in the second space. The first part and the second part have different dimensions.

### RELATED APPLICATION

The present application claims the benefit of Chinese Patent Application No. 202422854054.6, filed Nov. 21, 2024, titled “Retaining Clip,” the contents of which are hereby incorporated by reference.

### TECHNICAL FIELD

The present disclosure relates to a retaining clip, and in particular a retaining clip capable of clamping parts of different dimensions.

### BACKGROUND

There are tubes in vehicles for mounting wiring harnesses or cables. To avoid the movement of a tube, a retaining clip is usually used to clamp the tube to maintain the relative position of the tube. The retaining clip is connected to a vehicle body, and the tube is secured in the retaining clip, such that the tube is stably retained in the vehicle body.

### SUMMARY OF THE DISCLOSURE

The present disclosure relates generally to a retaining clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a retaining clip according to an embodiment.

FIG. 1B is a perspective view of the retaining clip in FIG. 1A from another perspective.

FIG. 2 is a side view of the retaining clip in FIG. 1A.

FIG. 3A is a side view of the retaining clip in FIG. 1 and a first part.

FIG. 3B is a side view of the retaining clip in FIG. 1A clamping the first part.

FIG. 4A is a side view of the retaining clip in FIG. 1 and a second part.

FIG. 4B is a side view of the retaining clip in FIG. 1A clamping the second part.

FIG. 5A is a perspective view of a retaining clip according to a second embodiment of the present disclosure.

FIG. 5B is a perspective view of the retaining clip in FIG. 5A from another perspective.

FIG. 6 is a side view of the retaining clip in FIG. 5A.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a retaining clip having a width direction, a height direction, and a length direction. The retaining clip includes a support, a first elastic arm and a second elastic arm. The support includes a base, a first supporting portion and a second supporting portion. The first supporting portion and the second supporting portion are respectively connected to two ends of the base and extend in a direction away from the base. The first elastic arm and a second elastic arm respectively extend from the first supporting portion and the second supporting portion toward the base. A distal end of the first elastic arm is closer to the base than the second elastic arm. The distal end of the first elastic arm and the base enclose a first space, and a distal end of the second elastic arm, a side of the first elastic arm facing the second supporting portion, and the base enclose a second space. The first elastic arm and the second elastic arm are configured to be elastic so as to clamp a first part in the first space or a second part in the second space. The first part and the second part have different dimensions.

In the above-mentioned retaining clip, the dimension of the first part is smaller than the dimension of the second part, and the second space is further away from the base than the first space in the height direction of the retaining clip.

In the above-mentioned retaining clip, the base includes a first recess having an opening, the first elastic arm extends toward the opening, and the distal end of the first elastic arm and the first recess enclose the first space.

In the above-mentioned retaining clip, an inner wall of the first recess includes an arc segment which is not smaller than half the circumference of the inner wall of the first recess, and an end face of the distal end of the first elastic arm is arc-shaped and is on the same circumference as the arc segment.

In the above-mentioned retaining clip, the base includes a second recess extending from one end of the first recess toward the second elastic arm and recessed toward the second supporting portion, and the second recess, the distal end of the second elastic arm and the first elastic arm enclose the second space.

In the above-mentioned retaining clip, an outer side of the first elastic arm is provided with a first retaining portion configured to be in contact with the second part when the second part is located in the second space. A minimum distance between the first retaining portion and the second recess is smaller than a diameter of the second part such that the first retaining portion and the second recess jointly restrict the movement of the second part toward the base.

In the above-mentioned retaining clip, the distal end of the first elastic arm has an elastic arm abutment portion, the first supporting portion has a mating portion, the first elastic arm is deformable to allow the elastic arm abutment portion to abut against the mating portion. One of the mating portion and the elastic arm abutment portion has a protrusion such that a hollowed portion is formed between the first elastic arm and the first supporting portion when the elastic arm abutment portion abuts against the mating portion.

In the above-mentioned retaining clip, the retaining clip further includes a third elastic arm extending from the first supporting portion toward the base and being spaced apart from the second elastic arm. A distal end of the third elastic arm, the side of the first elastic arm facing the second supporting portion and a side of the second elastic arm facing the first supporting portion enclose a third space. The first elastic arm, the second elastic arm and the third elastic arm are configured to clamp a third part in the third space. The dimension of the third part is greater than the dimension of the second part.

In the above-mentioned retaining clip, an outer side of the first elastic arm has a second retaining portion, an outer side of the second elastic arm has a third retaining portion, the second retaining portion and the third retaining portion being configured to be in contact with the third part when the third part is located in the third space. A minimum distance between the second retaining portion and the third retaining portion is smaller than a diameter of the third part such that the second retaining portion and the third retaining portion jointly restrict the movement of the third part toward the base.

In the above-mentioned retaining clip, the retaining clip includes an insertion portion connected to the base. The insertion portion is configured to be connected to a mounting location. The insertion portion includes a pin portion, and a pawl extending from the pin portion. The pawl is configured to mate with the mounting location. The retaining clip is integrally formed by an injection molding process.

The retaining clip in the present disclosure is capable of clamping parts of different dimensions to meet various dimensional requirements.

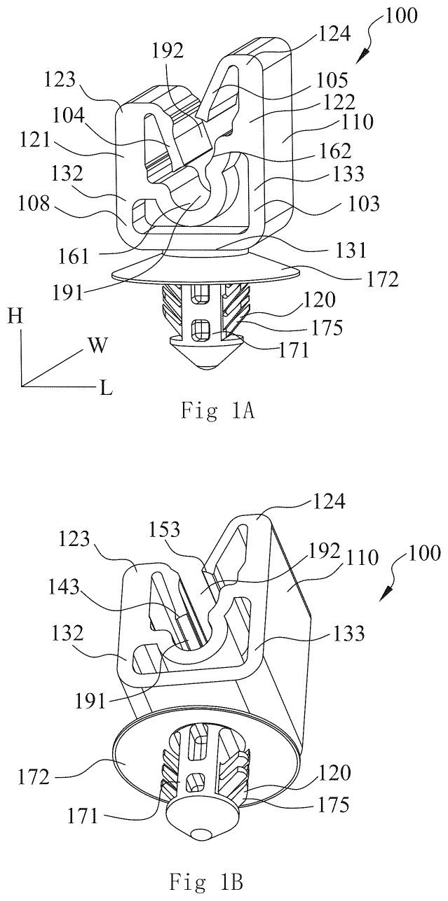

FIG. 1A is a perspective view of a retaining clip according to an embodiment, FIG. 1B is a perspective view of the retaining clip in FIG. 1A from another perspective, and FIGS. 1A and 1B show the structure of a retaining clip. As shown in FIGS. 1A and 1B, the retaining clip 100 includes a clamping portion 110 and an insertion portion 120, the clamping portion 110 is connected to the insertion portion 120. The clamping portion 110 is configured to clamp a part, such as a tube. The insertion portion 120 is configured to be connected to a mounting location, for example, inserted into a channel of the mounting location. The retaining clip 100 is configured to connect the tube to the mounting location, for example, to connect a tube for receiving a cable in a vehicle to a panel of the vehicle.

The insertion portion 120 includes a pin portion 171, a flange portion 172, and a pawl 175. The pin portion 171 is connected to the clamping portion 110. The flange portion 172 extends obliquely outwardly from the pin portion 171 in a direction away from the clamping portion 110. The flange portion 172 is arranged close to the clamping portion 110. The pawl 175 extends outwardly from an outer peripheral edge of the pin portion. The pawl 175 includes a plurality of spine-like structures arranged in sequence. When the insertion portion 120 enters the channel of the mounting location, the pawl 175 can be engaged with an inner wall of the channel of the mounting location, so as to connect the retaining clip to the mounting location. The flange portion 172 is configured to limit the depth of insertion of the retaining clip 100 into the channel of the mounting location along the insertion direction. Moreover, the flange portion 172 has a certain elasticity, and can be in contact with a surface at the mounting location, thereby providing a sealing function at the mounting channel.

The clamping portion 110 includes a support 103, a first elastic arm 104 and a second elastic arm 105. The support 103 includes a base 108, a first supporting portion 121, and a second supporting portion 122. The base 108 has a bottom portion 131, a first side portion 132 and a second side portion 133. The insertion portion 120 is connected to the bottom portion 131. In a length direction of the retaining clip 100, the first side portion 132 and the second side portion 133 respectively extend from two ends of the bottom portion 131 in a direction away from the insertion portion 120. In an embodiment of the present disclosure, the height of the first side portion 132 is smaller than the height of the second side portion 133. The first supporting portion 121 extends from the first side portion 132 in the direction away from the insertion portion 120, and the second supporting portion 122 extends from the second side portion 133 in the direction away from the insertion portion 120.

The first elastic arm 104 extends obliquely from a distal end 123 of the first supporting portion 121 toward the base 108 such that an included angle is formed between the first elastic arm 104 and the first supporting portion 121, and a distal end 143 of the first elastic arm 104 is spaced apart from the first supporting portion 121. The first elastic arm 104 has a certain elasticity so that its distal end 143 can move toward the first supporting portion 121 when subjected to a force.

Similarly, the second elastic arm 105 extends obliquely from a distal end 124 of the second supporting portion 122 toward the base 108 such that an included angle is formed between the second elastic arm 105 and the second supporting portion 122, and a distal end 153 of the second elastic arm 105 is spaced apart from the second supporting portion 122. The second elastic arm 105 has a certain elasticity so that its distal end 153 can move toward the second supporting portion 122 when subjected to a force.

The first supporting portion 121 and the second supporting portion 122 have similar structures but differ in their height arrangement, and the first elastic arm 104 and the second elastic arm 105 have similar structures but differ in their height arrangement. In a height direction of the retaining clip, the height of the second supporting portion 122 is greater than the height of the first supporting portion 121, and the height of the second elastic arm 105 is greater than the height of the first elastic arm 104. Each of the distal end 143 of the first elastic arm 104 and the distal end 153 of the second elastic arm 105 are spaced apart from the base 108. The distal end 143 of the first elastic arm 104 is closer to the base 108 than the distal end 153 of the second elastic arm 105.

The base 108 has a first recess 161 and a second recess 162, the first recess 161 is located below the second recess 162. In the length direction of the retaining clip, the first recess 161 is located approximately in the middle and the second recess 162 is located between the first recess 161 and the second supporting portion 122 and is arranged toward the first elastic arm 104. The first recess 161 and the distal end 143 of the first elastic arm 104 enclose a first space 191 capable of receiving a first part. The second recess 162, an outer side of the first elastic arm 104 and the distal end 153 of the second elastic arm 105 enclose a second space 192 capable of receiving a second part. In an embodiment of the present disclosure, both the first part and the second part are tubes, the diameter of the first part being greater than the diameter of the second part. The retaining clip in this embodiment can clamp tubes of different diameters to meet the requirements of different application scenarios.

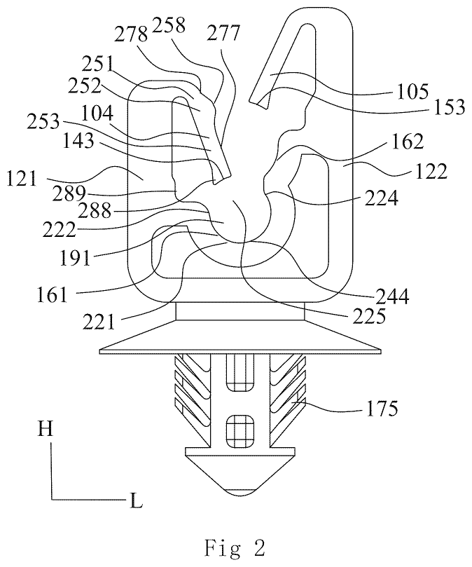

FIG. 2 is a side view of the retaining clip in FIG. 1A. As shown in FIG. 2, the first recess 161 is recessed from an upper portion of the base 108 toward the bottom portion 131 of the base 108. An inner wall 244 of the first recess 161 has an arc segment 221. The arc segment 221 extends in a circumferential direction and exceeds half the circumference of the inner wall 244 of the first recess 161. The arc segment 221 has a first end 222 close to the first supporting portion 121 and a second end 224 close to the second supporting portion 122. The second end 224 is higher than the first end 222 in the height direction H. An opening 225 is formed between the first end 222 and the second end 224. The opening 225 is slightly smaller than the diameter of the first part. The distal end 143 of the first elastic arm 104 is arranged toward the opening 225. An end face of the distal end 143 of the first elastic arm 104 is arc-shaped and is approximately on the circumference of the inner wall 244 of the first recess 161. The dimension of the first part match the circumference of the inner wall 244 of the first recess 161. When the first part is located in the first space 191, the first part is in contact with the end face of the distal end 143 of the first elastic arm 104 and the inner wall 244 of the first recess 161, and is thus clamped in the first space 191.

The second recess 162 extends from the first end 222 of the first recess 161 toward the second elastic arm 105 and is recessed toward the second supporting portion 122, and an inner wall of the second recess 162 is substantially arc-shaped. The first elastic arm 104 includes an upper section 251, a middle section 252 and a lower section 253. An outer side (i.e., the side away from the first supporting portion 121) of the middle section 252 protrudes outwardly to form a protrusion 258. An outer side of the lower section 253 has a first retaining portion 277, and an outer side of the upper section 251 has a second retaining portion 278. The second recess 162 is arranged toward the first retaining portion 277.

The distal end 143 of the first elastic arm 104 has an elastic arm abutment portion 288 protruding toward the first supporting portion 121, and the first supporting portion 121 has a mating portion 289 protruding from an inner side surface of the first supporting portion 121. The elastic arm abutment portion 288 can abut against the mating portion 289. The protruding configuration of the elastic arm abutment portion 288 and the mating portion 289 makes it possible to form a hollowed portion between the first elastic arm 104 and the first supporting portion 121 such that the first retaining portion 277 has a certain elasticity. The first retaining portion 277, the second recess 162 and the distal end 153 of the second elastic arm 105 jointly enclose the second space 192. The distal end 153 of the second elastic arm 105 is configured to be arc-shaped to match the shape of the second part.

In another embodiment of the present disclosure, it is sufficient for one of the elastic arm abutment portion 288 and the mating portion 289 to be configured as a protrusion, which can also make it possible to form a hollowed portion between the first elastic arm 104 and the first supporting portion 121.

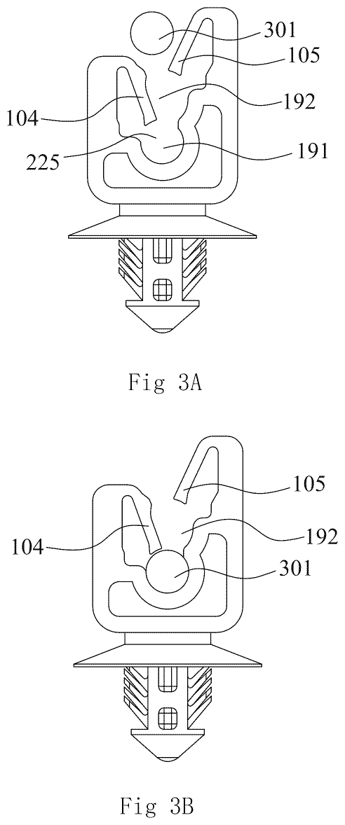

FIG. 3A is a side view of the retaining clip in FIG. 1 and the first part, and FIG. 3B is a side view of the retaining clip in FIG. 1A clamping the first part. As shown in FIGS. 3A and 3B, the first part 301 can be mounted into the first space 191 from above the retaining clip. In an embodiment of the present disclosure, the first part 301 is a cylindrical tube. When the first part 301 is mounted, the first part 301 is pushed into the space between the first elastic arm 104 and the second elastic arm 105, and a force is applied to the first part 301 such that the first elastic arm 104 and the second elastic arm 105 are deformed toward the first supporting portion 121 and the second supporting portion 122, respectively, and the first part 301 enters the second space 192. The force is then continuously applied to the first part 301, pressing the first elastic arm 104 to continue deforming toward the first supporting portion 121, and the first part 301 enters the opening 225 of the first recess 161. The force is continuously applied to the first part 301, the base 108 has a small amount of elasticity, and the first part 301 can pass through the opening 225 into the first space 191. In this case, the first elastic arm 104 returns to its original shape, and is located above the first part 301, and the first part 301 is clamped between the first elastic arm 104 and the first recess 161.

As shown in FIG. 3B, when the first part 301 is mounted in place within the first space 191, the first recess 161 can restrict a movement of the first part 301 in the length direction L and a downward movement of the first part in the height direction H, and the first elastic arm 104 can restrict an upward movement of the first part 301 in the height direction H, so that the first part 301 is stably clamped in the first space 191. The arc segment of the first recess 161 exceeds a semicircle, the opening 225 is smaller than the diameter of the first part 301, so that the first part 301 is not easily detached from the first space 191.

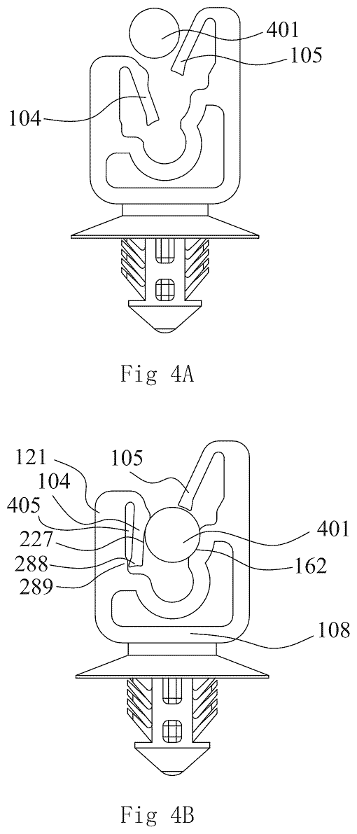

FIG. 4A is a side view of the retaining clip in FIG. 1A and the second part, and FIG. 4B is a side view of the retaining clip in FIG. 1A clamping the second part. As shown in FIGS. 4A and 4B, the second part 401 can be mounted into the second space 192 from above the retaining clip. In an embodiment of the present disclosure, the second part 401 is a cylindrical tube. When the second part 401 is mounted, the second part 401 is pushed into the space between the first elastic arm 104 and the second elastic arm 105, and a force is applied to the second part 401 such that the first elastic arm 104 and the second elastic arm 105 are deformed toward the first supporting portion 121 and the second supporting portion 122, respectively, and the second part 401 enters the second space 192. In this case, the elastic arm abutment portion of the first elastic arm 104 abuts against the first supporting portion, the second elastic arm 105 returns to its original shape and is located above the second part 401, so that the second part 401 is clamped between the first elastic arm 104, the second elastic arm 105 and the second recess 162.

As shown in FIG. 4B, when the second part 401 is mounted in place within the second space 192, the second part 401 presses the first retaining portion 227 of the first elastic arm 104 to bend and deform toward the first supporting portion 121, thereby forming a recess which matches the shape of the second part 401. The first retaining portion 227 is in contact with the second part 401. The second recess 162 has an arc-shaped inner wall to match the shape of the second part 401, and the second recess 162 is in contact with the second part 401. A distance between a lower end of the first retaining portion 227 and a lower end of the second recess 162 is smaller than the diameter of the second part 401, so that the second part 401 cannot be moved further toward the base 108. The second recess 162 and the first retaining portion 227 both restrict the movement of the second part 401 in the length direction L. The distal end of the second elastic arm 105 is located above the second part 401 and can restrict the upward movement of the second part 401 in the height direction. The second part 401 is thus restricted by the first retaining portion 227, the second elastic arm 105 and the second recess 162 and cannot be moved in either direction, so that the second part 401 is stably clamped in the second space 192.

The elastic arm abutment portion 288 of the first elastic arm 104 mates with the mating portion 289 of the first supporting portion 121 such that the first elastic arm 104 and the first supporting portion 121 form a hollowed portion 405. The hollowed portion 405 forms a deformation space, enabling the first retaining portion 227 to be bent toward the first supporting portion 121, to make better contact with the second part 401.

In the present disclosure, the dimension of the second part 401 is greater than the dimension of the first part 301 so that the first part 301 can pass through the second space 192 smoothly.

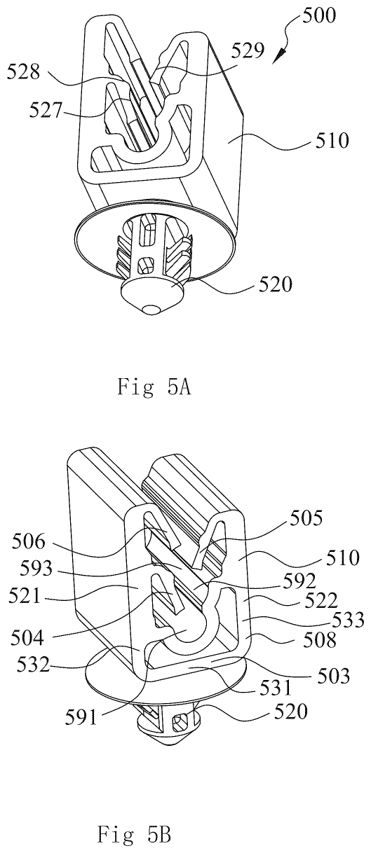

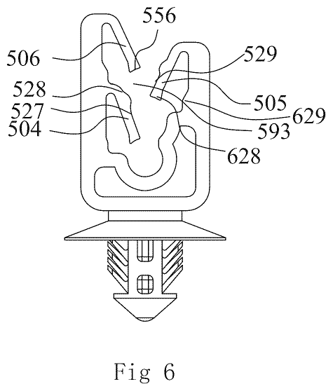

FIG. 5A is a perspective view of a retaining clip according to a second embodiment of the present disclosure, FIG. 5B is a perspective view of the retaining clip in FIG. 5A from another perspective, and FIG. 6 is a side view of the retaining clip in FIG. 5A.

The embodiment shown in FIG. 5A is similar to the embodiment shown in FIG. 1A except that the embodiment shown in FIG. 5A includes a third elastic arm such that a third space 593 can be formed to clamp a third part having a greater dimension than the second part.

As shown in FIGS. 5A, 5B and 6, similar to the embodiment shown in FIG. 1A, the retaining clip 500 includes a clamping portion 510 and an insertion portion 520. The insertion portion 520 is the same as the insertion portion 120 in FIG. 1A. The clamping portion 510 includes a support 503, a first elastic arm 504, a second elastic arm 505, and a third elastic arm 506. The support 503 includes a base 508, a first supporting portion 521, and a second supporting portion 522. The base 508 has a bottom portion 531, a first side portion 532 and a second side portion 533. The structure of the base 508 is the same as the structure of the base 508 of the retaining clip 100 in FIG. 1A. The height of the first supporting portion 521 is greater than the height of the first supporting portion 121 in the retaining clip 100 in FIG. 1A, the first elastic arm 504 is connected to the middle of the first supporting portion 521, the third elastic arm 506 is connected to a top portion of the first supporting portion 521, and the first elastic arm 504 and the third elastic arm 506 are arranged side by side, and have a spacing therebetween.

The first elastic arm 504 is of the same structure as the first elastic arm 104 in FIG. 1A and has a first retaining portion 527 and a second retaining portion 528. The second elastic arm 505 has a third retaining portion 529. The second elastic arm 505 has an elastic arm abutment portion 628, and the second supporting portion 522 has a mating portion 629, such that the third retaining portion 529 of the second elastic arm 505 has a similar effect as the first retaining portion 227 in FIG. 4A.

Similar to the embodiment shown in FIG. 1A, a third space 593 is formed between the second retaining portion 528, the third retaining portion 529, and a distal end 556 of the third elastic arm 506. The third part can be clamped in the third space 593. The second retaining portion 528, the third retaining portion 529 and the distal end 556 of the third elastic arm 506 can all be in contact with the third part, thereby clamping the third part and restricting the movement of the third part. The second retaining portion 528, the third retaining portion 529 and the distal end 556 of the third elastic arm 506 are in contact with three portions of the third part. The closest distance between adjacent two of the three portions of the third part is smaller than the diameter of the third part, such that the third part can be stably clamped in the third space.

When the third part is mounted in place within the third space 593, both the first elastic arm 504 and the second elastic arm 505 are deformed toward their respective supporting portions and can exert a certain elastic force on the third part such that the third part is less likely to be moved.

In this embodiment, the first space 591, the second space 592 and the third space 593 are dimensioned to match the first part, the second part and the third part. The dimension of the third part is set to be greater than the dimension of the second part, and the dimension of the second part is set to be greater than the dimension of the first part, so that the component of each dimension is easy to mount.

On the basis of the embodiment shown in FIG. 5A above, the retaining clip in the present disclosure may be provided with additional elastic arms to accommodate parts of more dimensions.

While the present disclosure has been described in conjunction with the examples of embodiments outlined above, various alternatives, modifications, variations, improvements and/or substantial equivalents, whether known or that are or may be presently foreseen, may become apparent to those having at least ordinary skill in the art. The technical effects and technical problems in the specification are exemplary and are not limiting. It should be noted that the embodiments described in the specification may have other technical effects and can solve other technical problems. Accordingly, the examples of embodiments of the present disclosure, as set forth above, are intended to be illustrative, not limiting. Various changes may be made without departing from the spirit or scope of the invention. Therefore, the present disclosure is intended to embrace all known or earlier developed alternatives, modifications, variations, improvements and/or substantial equivalents.

What is claimed is:

1. A retaining clip having a width direction, a height direction, and a length direction, the retaining clip comprising:
a support comprising a base, a first supporting portion and a second supporting portion, the first supporting portion and the second supporting portion being respectively connected to two ends of the base and extending in a direction away from the base; and
a first elastic arm and a second elastic arm respectively extending from the first supporting portion and the second supporting portion toward the base,
wherein a distal end of the first elastic arm is closer to the base than the second elastic arm, wherein the distal end of the first elastic arm and the base enclose a first space, and a distal end of the second elastic arm, a side of the first elastic arm facing the second supporting portion, and the base enclose a second space, and wherein the first elastic arm and the second elastic arm are configured to be elastic so as to clamp a first part in the first space or a second part in the second space, the first part and the second part having different dimensions.

2. The retaining clip of claim 1, wherein the dimension of the first part is smaller than the dimension of the second part, and the second space is further away from the base than the first space in the height direction of the retaining clip.

3. The retaining clip of claim 1, wherein the base comprises a first recess having an opening, the first elastic arm extending toward the opening, and the distal end of the first elastic arm and the first recess enclosing the first space.

4. The retaining clip of claim 3, wherein an inner wall of the first recess comprises an arc segment which is not smaller than half the circumference of the inner wall of the first recess, and an end face of the distal end of the first elastic arm is arc-shaped and is on the same circumference as the arc segment.

5. The retaining clip of claim 3, wherein the base comprises a second recess extending from one end of the first recess toward the second elastic arm and recessed toward the second supporting portion, the second recess, the distal end of the second elastic arm and the first elastic arm enclosing the second space.

6. The retaining clip of claim 5, wherein an outer side of the first elastic arm is provided with a first retaining portion configured to be in contact with the second part when the second part is located in the second space, and wherein a minimum distance between the first retaining portion and the second recess being smaller than a diameter of the second part such that the first retaining portion and the second recess jointly restrict the movement of the second part toward the base.

7. The retaining clip of claim 1, wherein the distal end of the first elastic arm has an elastic arm abutment portion, the first supporting portion has a mating portion, the first elastic arm being deformable to allow the elastic arm abutment portion to abut against the mating portion, and wherein one of the mating portion and the elastic arm abutment portion has a protrusion such that a hollowed portion is formed between the first elastic arm and the first supporting portion when the elastic arm abutment portion abuts against the mating portion.

8. The retaining clip of claim 1, further comprising a third elastic arm extending from the first supporting portion toward the base and being spaced apart from the second elastic arm, a distal end of the third elastic arm, the side of the first elastic arm facing the second supporting portion and a side of the second elastic arm facing the first supporting portion enclosing a third space, wherein the first elastic arm, the second elastic arm and the third elastic arm are configured to clamp a third part in the third space, the dimension of the third part being greater than the dimension of the second part.

9. The retaining clip of claim 8, wherein an outer side of the first elastic arm has a second retaining portion, an outer side of the second elastic arm has a third retaining portion, the second retaining portion and the third retaining portion being configured to be in contact with the third part when the third part is located in the third space, and wherein a minimum distance between the second retaining portion and the third retaining portion is smaller than a diameter of the third part such that the second retaining portion and the third retaining portion jointly restrict the movement of the third part toward the base.

10. The retaining clip of claim 1, wherein the retaining clip comprises an insertion portion connected to the base, the insertion portion being configured to be connected to a mounting location, wherein the insertion portion comprises a pin portion, and a pawl extending from the pin portion, the pawl being configured to mate with the mounting location, and the retaining clip being integrally formed by an injection molding process.
